(19) United States
(12) Patent Application Publication
(10) Pub. No.: US 2019/0203053 A1
(43) Pub. Date: Jul. 4, 2019

(54) PIGMENTS BASED ON LiSbO3 AND LiNbO3 RELATED STRUCTURES

(71) Applicant: The Shepherd Color Company, Cincinnati, OH (US)

(72) Inventor: William M. Yuhasz, West Chester, OH (US)

(21) Appl. No.: 16/225,574

(22) Filed: Dec. 19, 2018

Related U.S. Application Data
(63) Continuation-in-part of application No. 14/929,949, filed on Nov. 2, 2015, now Pat. No. 10,202,510.
(60) Provisional application No. 62/074,317, filed on Nov. 3, 2014.

(51) Int. Cl. C09C 1/00; C01G 51/00; C09C 3/04; C09C 1/36; C09C 1/62

(52) U.S. Cl. CPC C09C 1/0096; C09D 7/61; C09C 3/041; C09C 1/3607; C09C 1/627; C01P 2002/72; C01P 2002/84; C01P 2004/51; C01P 2004/61; C01P 2006/66; C01P 2002/52; C01P 2002/76; C01P 2002/77; C01P 2006/63; C01P 2006/64; C01P 2006/62; C01G 51/42

(57) ABSTRACT

The present invention involves pigments derived from compounds with the LiSbO₃-type or LiNbO₃-type structures. These compounds possess the following formulations M¹M⁵Z₃, M¹M²M⁴M⁵Z₆, M¹M³₂M⁵Z₆, M¹M²M³M⁶Z₆, M¹₂M⁴M⁶Z₆, M¹M⁵M⁶Z₆, or a combination thereof. The cation M¹ represents an element with a valence of +1 or a mixture thereof, the cation M² represents an element with a valence of +2 or a mixture thereof, the cation M³ represents an element with a valence of +3 or a mixture thereof, the cation M⁴ represents an element with a valence of +4 or a mixture thereof, the cation M⁵ represents an element with a valence of +5 or a mixture thereof, and the cation M⁶ represents an element with a valence of +6 or a mixture thereof. The cation M is selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, or Te. The anion Z is selected from N, O, S, Se, Cl, F, hydroxide ion or a mixture thereof. Along with the elements mentioned above vacancies may also reside on the M or Z sites of the above formulations such that the structural type is retained. The above formula may also include M dopant additions below 20 atomic %, where the dopant is selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, Bi, Te, or mixtures thereof.

### CROSS-REFERENCE TO RELATED APPLICATIONS

This application claims priority to U.S. provisional application No. 62/074,317, entitled, “Pigments based on LiSbO₃ and LiNbO₃ related structures,” filed Nov. 3, 2014, which is incorporated by reference herein in its entirety.

### BACKGROUND

Pigments based on the LiSbO₃ and LiNbO₃ type structures have not been reported. Materials with these crystal structure types have been studied in relation to piezoelectric, linear, and nonlinear optical material applications. The following work discloses a wide range of new pigment types based on LiSbO₃-type and LiNbO₃-type structures. These materials possess unique coloristic qualities as well as unusually high chemical stability.

### BRIEF SUMMARY

The pigments disclosed in this work are compounds that possess a crystal structure related to the LiSbO₃-type or LiNbO₃-type structures. These structures possess chemical formulas with the following variations:

M¹M⁵Z₃,

M¹M²M⁴M⁵Z₆,

M¹M³₂M⁵Z₆,

M¹M²M³M⁶Z₆,

M¹₂M⁴M⁶Z₆,

M¹M⁵M⁶Z₆,

or combination thereof,
where the cation M¹ is an element with a valence of +1 or a mixture thereof;
where the cation M² is an element with a valence of +2 or a mixture thereof;
where the cation M³ is an element with a valence of +3 or a mixture thereof;
where the cation M⁴ is an element with a valence of +4 or a mixture thereof;
where the cation M⁵ is an element with a valence of +5 or a mixture thereof;
where the cation M⁶ is an element with a valence of +6 or a mixture thereof;
with M selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, or Te; where the anion Z is selected from N, O, S, Se, Cl, F, hydroxide ion or a mixture thereof; and where vacancies may reside on the M or Z site such that the structural type is retained. The term dopant is used to refer to substitutions that result in a deficiency or excess of the anion Z away from the ideal stoichiometry without substantially changing the structure. As well as variants that include M dopant additions below 20 atomic %, where the dopant is selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, Bi, Te, or mixtures thereof.

A detailed explanation and illustrative examples of the above composition range follow below.

### BRIEF DESCRIPTION OF DRAWINGS

FIGS. 1(a) and (b): Cross section views of LiSbO₃ crystal structure (antimony (small red spheres) lithium (medium yellows spheres) oxygen (large blue spheres)). The unit cell is outlined in black with four making up each projection.

FIGS. 2(a) and (b): Cross section views of LiNbO₃ crystal structure (niobium (small red spheres) lithium (medium yellows spheres) oxygen (large blue spheres)). The unit cell is outlined in black with four making up each projection.

FIG. 3: Powder X-ray diffraction patterns for Examples 1 to 5 along with phase pure LiSbO₃ synthesized in the same manner. The ICDD PDF#77-0824 for LiSbO₃ is displayed for comparison. The gray lines are guides to compare relative peak positions.

FIG. 4: Powder X-ray diffraction pattern for Example 6 along with phase pure LiSbO₃ synthesized in the same manner. The ICDD PDF#44-1075 for LiCoSnSbO₆ is displayed for comparison. The gray lines are guides to compare relative peak positions.

FIG. 5: Powder X-ray diffraction patterns for Examples 7 and 8 along with phase pure LiNbO₃ and LiTaO₃ synthesized in the same manner. The ICDD PDF#82-0459 for LiNbO₃ is displayed for comparison. The gray lines are guides to compare relative peak positions.

FIG. 6: Reflectance spectra for Examples 1 to 5 measured from 250 to 2500 nm. Measurements were made on PVDF/acrylic masstone drawdowns with a 2.2 mil dry film thickness over primed aluminum.

FIG. 7: Reflectance spectrum for Example 6 measured from 250 to 2500 nm with Example 4 displayed for comparison. Measurements were made on PVDF/acrylic masstone drawdowns with a 2.2 mil dry film thickness over primed aluminum.

FIG. 8: Reflectance spectra for Examples 7 and 8 measured from 250 to 2500 nm with Example 4 displayed for comparison. Measurements were made on PVDF/acrylic masstone drawdowns with a 2.2 mil dry film thickness over primed aluminum.

FIG. 9: ΔE* as a function of time over eight Kesternich cycles.

FIG. 10: ΔE* as a function of time over eight Kesternich cycles.

FIG. 11: Δ60° Gloss as a function of time over eight Kesternich cycles.

FIG. 12: Δ60° Gloss as a function of time over eight Kesternich cycles.

FIG. 13: PVDF/acrylic coatings on primed aluminum panels using Shepherd Color Violet 92 and Example 4. The panel on the left shows Shepherd Color Violet 92 following 24 hours of exposure to a 5% HCl solution. The center panel shows Example 4, which did not change in color following seven days of exposure to 5% HCl or 5% NaOH solutions. The right panel shows Shepherd Color Violet 92 following 24 hours of exposure to 5% NaOH solution.

### DETAILED DESCRIPTION

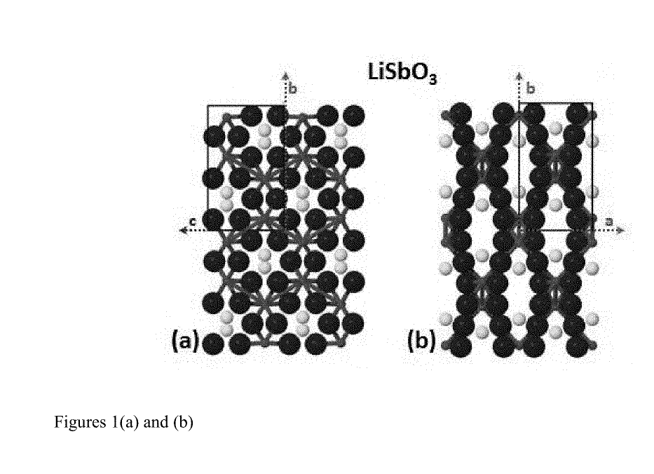

LiSbO₃ and LiNbO₃ both have unique structures. The LiSbO₃-type structure has an orthorhombic crystal structure with space group Pncn or in the case of ordered LiSbO₃-type structural variants with space group Pnn2. In the ideal LiSbO₃-type structure consists of oxygen atoms form a distorted hexagonal close packed array (FIG. 1a) with two thirds of the octahedral voids filled by both lithium (yellow spheres) and antimony (red spheres) as shown in FIGS. 1a and 1b. The LiSbO₃-type structure features a chain of offset edge-sharing antimony (SbO₆) octahedra that run along the c-axis (FIGS. 1a and 1b). In the parent LiSbO₃-type structure antimony uniformly occupies these chains, but in related structures, an ordered array of two cations may reside on the antimony site shifting the space group from Pncn to Pnn2.

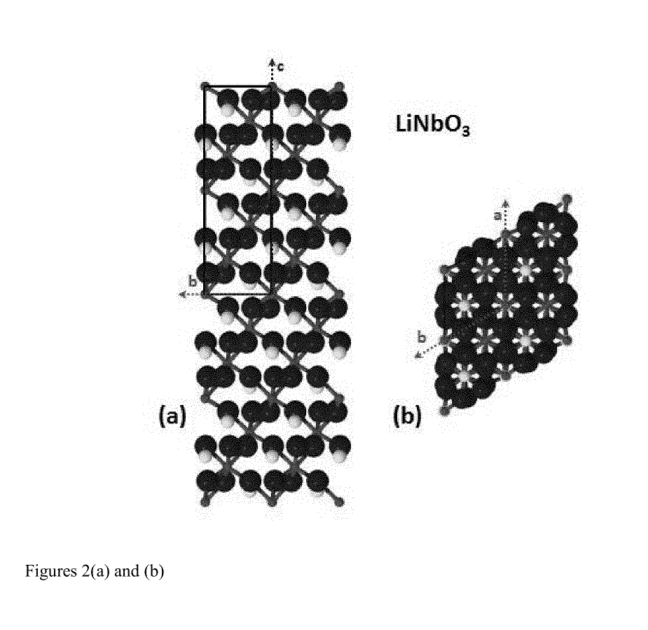

The LiNbO₃-type structure is a trigonal crystal structure with space group R3c (FIGS. 2a and 2b). The crystal structure can be considered an ordered variant of the ilmenite structure. Much like the LiSbO₃-type structure the LiNbO₃-type structure consists of a hexagonal close packed array of oxygen atoms forming distorted octahedral voids that are partially filled by lithium and niobium. Unlike the edge-shared SbO₆ octahedra of LiSbO₃-type structure the NbO₆ octahedra of the LiNbO₃-type structure are corner-shared.

Slight variances may occur in the space group for above structures where substitutions on the Sb/Nb site leads to additional ordering that increases structural symmetry from Pncn to Pnn2. In general the primary space group for the LiSbO₃-type structure falls under No. 52 from the International Tables for Crystallography, but related structures have fallen under No. 56 and 34. Subgroups of space group No. 52 include No. 34, No. 33, No. 30, No. 017, No. 014, and No. 013 for k-index 1. The primary space group for the LiNbO3-type structure falls under No. 161 from the International Tables for Crystallography. A subgroup of space group No. 161 includes No. 146 for k-index 1.

The pigments of the present invention possess a crystal structure related to the LiSbO₃-type or LiNbO₃-type structures. These structures possess chemical formulas with the following variations:

M¹M⁵Z₃,

M¹M²M⁴M⁵Z₆,

M¹M³₂M⁵Z₆,

M¹M²M³M⁶Z₆,

M¹₂M⁴M⁶Z₆,

M¹M⁵M⁶Z₆,

or combination thereof,
where the cation M¹ is an element with a valence of +1 or a mixture thereof;
where the cation M² is an element with a valence of +2 or a mixture thereof;
where the cation M³ is an element with a valence of +3 or a mixture thereof;
where the cation M⁴ is an element with a valence of +4 or a mixture thereof;
where the cation M⁵ is an element with a valence of +5 or a mixture thereof;
where the cation M⁶ is an element with a valence of +6 or a mixture thereof;
with M selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, or Te, where the anion Z is selected from N, O, S, Se, Cl, F, hydroxide ion or a mixture thereof; and where vacancies may reside on the M or Z site such that the structural type is retained. The term dopant is used to refer to substitutions that result in a deficiency or excess of the anion Z away from the ideal stoichiometry without substantially changing the structure. As well as variants that include M dopant additions below 20 atomic %, where the dopant is selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, Bi, Te, or mixtures thereof. Also, in another example, for the formula M¹M⁵Z₆, M¹ may at least be greater than 50 atomic % Li, and M⁵ may at least be greater than 50 atomic % Sb. Further, in another example, where the chemical formula is selected from: (M¹M⁵)₂₋ₓ(M²M⁴)ₓZ₆, where 0<x<1; (M¹M⁵)₂₋ₓ(M³M³)ₓZ₆, where 0<x<1; or combinations thereof, M¹ may at least be greater than 50 atomic % lithium, and M² may at least be greater than 50 atomic % cobalt.

Other pigments, derived from solid solutions, may include those between M¹M⁵Z₃ and M¹M²M⁴M⁵Z₆ of the form (M¹M⁵)₂₋ₓ(M²M⁴)ₓZ₆ where 0<x<1 and between M¹M⁵Z₃ and M¹M³M³M⁵Z₆ of the form (M¹M⁵)₂₋ₓ(M³M³)ₓZ₆ where 0<x<1. Pigments may also be solid solutions between (M¹M⁵)₂₋ₓ(M²M⁴)ₓZ₆ and (M¹M⁵)₂₋ₓ(M³M³)ₓZ₆ where 0<x<1. Specifically, such pigments may include (LiSb)₂₋ₓ(CoTi)ₓO₆, where 0<x<1, and where the pigment ranges from a pastel pink to a violet to a dull purple color; or where x=0.8, and the pigment is a violet color. Other pigments may include (LiSb)₂₋ₓ(CoSn)ₓO₆, where 0<x<1, and where the pigment ranges from a pastel pink to a red-shade violet to a dull red-shade violet color and when x=0.5, and the pigment is a red-shade violet color. Other pigments may also include (LiNb)₂₋ₓ(CoTi)ₓO₆, where 0<x<0.4 and where the pigment ranges from a off-white to a pastel purple to a dull purple shade black color, and when x=0.1, and the pigment is a pastel purple color. Other pigments may include (LiTa)₂₋ₓ(CoTi)ₓO₆ where 0<x<0.4, and where the pigment ranges from an off-white to a violet to a dull purple color, and when x=0.2, the pigment is a light violet color. Pigments of the form (M¹M⁵)₂₋ₓ(M³M³)ₓZ₆ may include (LiSb)₂₋ₓ(Fe₂)ₓO₆, where 0<x<1, and where the pigment ranges from an off-white to a yellow shade brown. Pigments with M dopant additions may be formed such as (Co,Al) doped LiSbO3 where the cobalt content is at 4 atomic % and the aluminum content is at 10 atomic % resulting a violet pigment.

Compounds in this technology may also include a LiSbO₃-type or LiNbO₃-type structure, with a chemical formula selected from the following formulae:

(M¹M⁵)₂₋ₓ(M²M⁴)ₓZ₆, where 0<x<1,

(M¹M⁵)₂₋ₓ(M³M³)ₓZ₆, where 0<x<1,

(M¹M²M³)₂₋ₓ(M⁶)ₓZ₆, where 0<x<1,

(M¹M¹M⁴)₂₋ₓ(M⁶)ₓZ₆, where 0<x<1,

(M¹M⁵)₂₋ₓ(M⁶)ₓZ₆, where 0<x<1,

or combination thereof,
where the cation M¹ is an element with a valence of +1 or a mixture thereof,
where the cation M² is an element with a valence of +2 or a mixture thereof,
where the cation M³ is an element with a valence of +3 or a mixture thereof,
where the cation M⁴ is an element with a valence of +4 or a mixture thereof,
where the cation M⁵ is an element with a valence of +5 or a mixture thereof,
where the cation M⁶ is an element with a valence of +6 or a mixture thereof,
where M selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, or Te, where the anion Z is selected from N, O, S, Se, Cl, F, hydroxide ion or a mixture thereof, where vacancies may reside on the M or Z site such that the structural type is retained. The term dopant is used to refer to substitutions that result in a deficiency or excess of the anion Z away from the ideal stoichiometry without substantially changing the structure. As well as variants that include M dopant additions below 20 atomic %, where the dopant is selected from H, Li, Na, K, Rb, Cs, Mg, Ca, Sr, Ba, Sc, Y, La, Ce, Pr, Nd, Sm, Eu, Gd, Tb, Dy, Ho, Er, Tm, Yb, Lu, Ti, Zr, Hf, V, Nb, Ta, Cr, Mo, W, Mn, Fe, Ru, Co, Ni, Cu, Ag, Zn, B, Al, Ga, In, Si, Ge, Sn, P, Sb, Bi, Te, or mixtures thereof.

Potential uses for these materials may be in sol-gel type coatings and coil coatings (PVDF, polyester) as well as in cement, roofing granules, paint, ink, glass, enamel, ceramic glaze, plastics, sol-gel coatings, or decorative cosmetic applications.

Synthesis Routes:

There are multiple synthetic methods that may be employed to synthesize these materials. These include solid state sintering, solution synthesis (hydrothermal, precipatation, flame spray pyrolosis, and combustion synthesis), and ion exchange (through solution or molten salt techniques).

One method involves the use of the solid state sintering technique. The approriate elemental precursors (including oxides, carbonates, hydroxides, etc.) at the desired stoichiometry are intimately mixed and fired at temperatures ranging from 900° F. to 2300° F. under various atmospheres depending on the selected precursors. The resulting material is then milled to the desired size scale and color. Various sintering aids/mineralizers may be employed as well to reduce the firing temperature and minimize the loss of volatile constituents.

A surface coating/treatment may be applied to the resulting pigment for stabilization or functionalization in a range of applications.

The pigment may be incorporated into, or synthesized as part of, a composite material to either impart a benefit or functionality to the composite or to improve or enhance a property of the pigment.

### EXAMPLES

### Example 1

A mixture of 4.45 grams of cobalt oxide (Co₃O₄), 4.43 grams of titanium dioxide (TiO₂), 18.43 grams of lithium carbonate (Li₂CO₃), and 72.70 grams of antimony trioxide (Sb₂O₃) was homogenized using a Waring blender and calcined at 2,150° F. for 4 hours in air. The resulting material is a red-shade violet which can be milled to a pigmentary particle size that is light red-shade violet in coloration. A reversible color shift from light red-shade violet at room temperature to gray at 660° F. occurs.

### Example 2

A mixture of 9.01 grams of cobalt oxide (Co₃O₄), 8.96 grams of titanium dioxide (TiO₂), 16.59 grams of lithium carbonate (Li₂CO₃), and 65.44 grams of antimony trioxide (Sb₂O₃) was homogenized using a Waring blender and calcined at 2,150° F. for 4 hours in air. The resulting material is bright violet which can be milled to a pigmentary particle size that is light violet in coloration. A reversible color shift from light violet at room temperature to gray at 660° F. occurs.

### Example 3

A mixture of 13.69 grams of cobalt oxide (Co₃O₄), 13.62 grams of titanium dioxide (TiO₂), 14.70 grams of lithium carbonate (Li₂CO₃), and 57.99 grams of antimony trioxide (Sb₂O₃) was homogenized using a Waring blender and calcined at 2,150° F. for 4 hours in air. The resulting material is bright violet which can be milled to a pigmentary particle size that is violet in coloration. A reversible color shift from violet at room temperature to gray at 660° F. occurs.

### Example 4

A mixture of 18.49 grams of cobalt oxide (Co₃O₄), 18.39 grams of titanium dioxide (TiO₂), 12.76 grams of lithium carbonate (Li₂CO₃), and 50.35 grams of antimony trioxide (Sb₂O₃) was homogenized using a Waring blender and calcined at 2,150° F. for 4 hours in air. The resulting material is bright purple which can be milled to a pigmentary particle size that is light purple in coloration. A reversible color shift from light purple at room temperature to gray at 660° F. occurs. This substance is also stable in a glass frit and sol-gel based coatings.

### Example 5

A mixture of 23.42 grams of cobalt oxide (Co₃O₄), 23.29 grams of titanium dioxide (TiO₂), 10.78 grams of lithium carbonate (Li₂CO₃), and 42.51 grams of antimony trioxide (Sb₂O₃) was homogenized using a Waring blender and calcined at 2,150° F. for 4 hours in air. The resulting material has a purple color which can be milled to a pigmentary particle size that is dull purple in coloration. A reversible color shift from dull purple at room temperature to gray at 660° F. occurs.

### Example 6

A mixture of 15.90 grams of cobalt oxide (Co₃O₄), 29.84 grams of stannic oxide (SnO₂), 10.97 grams of lithium carbonate (Li₂CO₃), and 43.29 grams of antimony trioxide (Sb₂O₃) was homogenized using a Waring blender and calcined at 2,000° F. for 4 hours in air. The resulting material is a red-shade violet which can be milled to a pigmentary particle size that is light red-shade violet coloration.

### Example 7

A mixture of 2.37 grams of cobalt oxide (Co₃O₄), 2.36 grams of titanium dioxide (TiO₂), 20.72 grams of lithium carbonate (Li₂CO₃), and 74.55 grams of niobium pentoxide (Nb₂O₅) was homogenized using a Waring blender and calcined at 1,800° F. for 4 hours in air. The resulting material is purple which can be milled to a pigmentary particle size that is pastel purple in coloration.

### Example 8

A mixture of 3.24 grams of cobalt oxide (Co₃O₄), 3.22 grams of titanium dioxide (TiO₂), 13.40 grams of lithium carbonate (Li₂CO₃), and 80.14 grams of tantalum pentoxide (Ta₂O₅) was homogenized using a Waring blender and calcined at 1,920° F. for 4 hours in air. The resulting material has violet color which can be milled to a pigmentary particle size that is light violet in coloration.

### Example 9

A mixture of 6.47 grams of cobalt carbonate (CoCO₃), 4 grams of titanium dioxide (TiO₂), 16.65 grams of lithium carbonate (Li₂CO₃), and 72.89 grams of antimony pentoxide (Sb₂O₅) was homogenized using a Waring blender and calcined at 2,010° F. for 4 hours under flowing argon. The resulting material has a purple which can be milled to a pigmentary particle size that is light purple in coloration.

### Example 10-18

Mixtures of cobalt oxide (Co₃O₄), titanium dioxide (TiO₂), lithium carbonate (Li₂CO₃), antimony trioxide (Sb₂O₃), stannic oxide (SnO₂) and cobalt phosphate octahydrate (Co₃(PO₄)2.8H₂O) were weighed out in proportions according to the molar amounts listed in Table 1. The mixtures were homogenized by mortar and pestle and calcined in air at 1,093° C. for 4 hours. After firing, the color of the final product is listed in Table 1 and ranged from pale light violet to brown.

TABLE 1
Composition, firing temperature and color data for Examples 10 to 16. CIE
color values for Examples 10-16 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | SnO₂ | Co₃(PO₄)₂•8H₂O | | Firing | | | | | | |
|---|---|---|---|---|---|---|---|---|---|---|---|---|---|---|
| Example | mol Co | mol Ti | mol Li | mol Sb | mol Sn | mol Co | mol P | Temperature | L* | a* | b* | C* | h° | Color |
| 10 | 0.8 | 0.6 | 1.2 | 1.2 | 0.2 | | | 1,093° C. | 47.9 | 17.8 | −20.3 | 27.0 | 311.3 | Pale Light Violet |
| 11 | 0.8 | 0.4 | 1.2 | 1.2 | 0.4 | | | 1,093° C. | 50.5 | 21.4 | −22.1 | 30.8 | 314.0 | Pale Light Purple |
| 12 | 0.8 | 0.2 | 1.2 | 1.2 | 0.6 | | | 1,093° C. | 52.9 | 23.3 | −20.7 | 31.2 | 318.4 | Pale Light Purple |
| 13 | 0.8 | | 1.2 | 1.2 | 0.8 | | | 1,093° C. | 54.1 | 20.3 | −12.3 | 23.7 | 328.9 | Pale Light Pink |
| 14 | 0.9 | 1 | 1 | 0.93 | | 0.1 | 0.07 | 1,093° C. | 31.9 | 7.7 | −6.9 | 10.4 | 318.1 | Very Pale Dark |
| | | | | | | | | | | | | | | Purple |
| 15 | 0.8 | 1 | 1 | 0.87 | | 0.2 | 0.13 | 1,093° C. | 32.9 | 8.0 | 2.3 | 8.4 | 15.8 | Purple Shade Brown |
| 16 | 0.7 | 1 | 1 | 0.8 | | 0.3 | 0.2 | 1,093° C. | 31.9 | 6.7 | 8.6 | 10.9 | 52.2 | Brown |

### Example 17-26

Mixtures of cobalt oxide (Co₃O₄), titanium dioxide (TiO₂), lithium carbonate (Li₂CO₃), antimony trioxide (Sb₂O₃), cupric oxide (CuO) and nickel oxide (NiO) were weighed out in proportions according to the molar amounts listed in Table 2. The mixtures were homogenized by mortar and pestle and calcined in air at temperatures ranging from 980° C. to 1,180° C. for 4 hours. After firing, the color of the final product is listed in Table 2 and ranged from bright violet to light yellow.

TABLE 2
Composition, firing temperature and color data for Examples 17 to 26. CIE
color values for Examples 17-26 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | CuO | NiO | Firing | | | | | | |
|---|---|---|---|---|---|---|---|---|---|---|---|---|---|
| Example | mol Co | mol Ti | mol Li | mol Sb | mol Cu | mol Ni | Temperature | L* | a* | b* | C* | h° | Color |
| 17 | 0.4 | 0.4 | 1.6 | 1.6 | | | 1,180° C. | 44.5 | 24.9 | −29.8 | 33.8 | 309.9 | Bright Violet |
| 18 | 0.6 | 0.6 | 1.4 | 1.4 | | | 1,180° C. | 44.0 | 21.4 | −28.0 | 35.2 | 307.5 | Bright Violet |
| 19 | 0.8 | 0.8 | 1.2 | 1.2 | | | 1,180° C. | 39.9 | 16.0 | −23.3 | 28.3 | 304.5 | Violet |
| 20 | 1 | 1 | 1 | 1 | | | 1,180° C. | 33.4 | 9.1 | −16.6 | 18.9 | 298.6 | Pale Violet |
| 21 | | 0.5 | 1.5 | 1.5 | 0.5 | | 980° C. | 63.9 | −6.2 | 27.5 | 28.2 | 102.6 | Pale Pastel Yellow Green |
| 22 | | 0.8 | 1.2 | 1.2 | 0.8 | | 980° C. | 69.8 | −8.5 | 37.0 | 37.9 | 102.9 | Pale Yellow Green |
| 23 | | 1 | 1 | 1 | 1 | | 980° C. | 57.7 | −8.6 | 38.9 | 39.9 | 102.4 | Pale Yellow Green |
| 24 | | 0.5 | 1.5 | 1.5 | | 0.5 | 1,050° C. | 82.8 | 0.2 | 52.5 | 52.5 | 89.7 | Light Yellow |
| 25 | | 0.8 | 1.2 | 1.2 | | 0.8 | 1,050° C. | 82.0 | 4.4 | 57.3 | 57.5 | 85.6 | Light Yellow |
| 26 | | 1 | 1 | 1 | | 1 | 980° C. | 85.2 | 4.1 | 55.3 | 55.4 | 85.7 | Light Yellow |

### Example 27-32

Mixtures of cobalt oxide (Co₃O₄), titanium dioxide (TiO₂), lithium carbonate (Li₂CO₃), antimony trioxide (Sb₂O₃), niobium pentoxide (Nb₂O₅) and tantalum pentoxide (NiO) were weighed out in proportions according to the molar amounts listed in Table 3. The mixtures were homogenized by mortar and pestle and calcined in air at temperatures ranging from 1,050° C. or 1,120° C. for 4 hours. After firing, the color of the final product is listed in Table 3 and the colors were shades of blue lilac.

TABLE 3
Composition, firing temperature and color data for Examples 27 to 32. CIE
color values for Examples 27-32 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Nb₂O₅ | Ta₂O₅ | Firing | | | | | | |
|---|---|---|---|---|---|---|---|---|---|---|---|---|
| Example | mol Co | mol Ti | mol Li | mol Nb | mol Ta | Temperature | L* | a* | b* | C* | h° | Color |
| 27 | 0.1 | 0.1 | 1.9 | 1.9 | | 1,050° C. | 55.3 | 14.3 | −32.8 | 35.7 | 293.5 | Blue Lilac |
| 28 | 0.2 | 0.2 | 1.8 | 1.8 | | 1,050° C. | 46.7 | 6.4 | −21.2 | 22.1 | 286.9 | Pale Blue Lilac |
| 29 | 0.4 | 0.4 | 1.6 | 1.6 | | 1,050° C. | 39.3 | 0.6 | −6.9 | 6.9 | 274.7 | Very Pale Dark Lilac |
| 30 | 0.1 | 0.1 | 1.9 | | 1.9 | 1,120° C. | 75.3 | 16.0 | −27.1 | 31.5 | 300.5 | Pastel Blue Lilac |
| 31 | 0.2 | 0.2 | 1.8 | | 1.8 | 1,120° C. | 64.5 | 16.3 | −29.3 | 33.6 | 299.1 | Pastel Blue Lilac |
| 32 | 0.4 | 0.4 | 1.6 | | 1.6 | 1,120° C. | 50.6 | 9.0 | −18.9 | 20.9 | 295.4 | Pale Blue Lilac |

### Example 33-44

Mixtures of cobalt oxide (Co₃O₄), titanium dioxide (TiO₂), lithium carbonate (Li₂CO₃), antimony trioxide (Sb₂O₃), cupric oxide (CuO), nickel oxide (NiO) and antimony pentoxide (Sb₂O₅) were weighed out in proportions according to the molar amounts listed in Table 4. The mixtures were homogenized by mortar and pestle and calcined in air at temperatures ranging from 900° C. or 1,180° C. for 4 hours. After firing, the color of the final product is listed in Table 4 and the colors were shades of blue lilac.

TABLE 4
Composition, firing temperature and color data for Examples 33 to 44. CIE
color values for Examples 33-44 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | CuO | NiO | Sb₂O₅ | Firing | | | | | | |
|---|---|---|---|---|---|---|---|---|---|---|---|---|---|---|
| Example | mol Co | mol Ti | mol Li | mol Sb | mol Cu | mol Ni | mol Sb | Temperature | L* | a* | b* | C* | h° | Color |
| 33 | 0.2 | 0.2 | 1.8 | 1.8 | | | | 1,180° C. | 60.5 | 23.9 | −25.0 | 34.6 | 313.7 | Pale Light Purple |
| 34 | 0.4 | 0.4 | 1.6 | 1.6 | | | | 1,180° C. | 48.5 | 24.6 | −28.9 | 38.0 | 310.4 | Bright Violet |
| 35 | 0.6 | 0.6 | 1.4 | 1.4 | | | | 1,180° C. | 46.6 | 21.0 | −27.2 | 34.4 | 307.7 | Bright Violet |
| 36 | 0.8 | 0.8 | 1.2 | 1.2 | | | | 1,180° C. | 41.3 | 16.1 | −23.6 | 28.6 | 304.2 | Violet |
| 37 | 1 | 1 | 1 | 1 | | | | 1,180° C. | 37.9 | 9.1 | −16.9 | 19.2 | 298.4 | Pale Violet |
| 38 | | 1 | 1 | | 1 | | 1 | 900° C. | 57.0 | −5.3 | 39.2 | 39.5 | 97.7 | Pale Yellow Green |
| 39 | | 1 | 1 | | | 1 | 1 | 900° C. | 84.6 | 0.2 | 49.0 | 49.0 | 89.7 | Pale Light Yellow |
| 40 | 0.2 | 0.2 | 1.8 | | | | 1.8 | 1,180° C. | 57.2 | 14.0 | −8.0 | 16.1 | 330.2 | Mauve |
| 41 | 0.4 | 0.4 | 1.6 | | | | 1.6 | 1,180° C. | 47.0 | 13.6 | −9.5 | 16.6 | 325.0 | Dark Mauve |
| 42 | 0.6 | 0.6 | 1.4 | | | | 1.4 | 1,180° C. | 40.3 | 12.2 | −10.9 | 16.4 | 318.2 | Very Pale Purple |
| | | | | | | | | | | | | | | Violet |
| 43 | 0.8 | 0.8 | 1.2 | | | | 1.2 | 1,180° C. | 35.5 | 10.4 | −13.2 | 16.8 | 308.0 | Very Pale Purple |
| | | | | | | | | | | | | | | Violet |
| 44 | 1 | 1 | 1 | | | | 1 | 1,180° C. | 33.2 | 7.2 | −14.4 | 16.1 | 296.4 | Pale Violet |

### Example 45-50

Mixtures of cobalt oxide (Co₃O₄), titanium dioxide (TiO₂), lithium carbonate (Li₂CO₃), antimony trioxide (Sb₂O₃), cobalt carbonate (CoCO₃), cobalt hydroxide (Co(OH)₂), lithium hydroxide monohydrate (LiOH.H₂O), lithium antimonate (LiSbO₃), lithium cobalt oxide (LiCoO₂) and antimony pentoxide(Sb₂O₅) were weighed out in proportions according to the molar amounts listed in Table 5. The mixtures were homogenized by mortar and pestle and calcined in air at 1,150° C. for 4 hours. After firing, the color of the final product is listed in Table 5 and the colors ranged from pale dark purple to pale violet.

TABLE 5
Composition, firing temperature and color data for Examples 45 to 50. CIE
color values for Examples 45-50 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | CoCO₃ | Co(OH)₂ | LiOH•H₂O | LiSbO₃ | |
|---|---|---|---|---|---|---|---|---|---|
| Example | mol Co | mol Ti | mol Li | mol Sb | mol Co | mol Co | mol Li | mol Li | mol Sb |
| 45 | | 0.8 | 1.2 | 1.2 | 0.8 | | | | |
| 46 | | 0.8 | 1.2 | 1.2 | | 0.8 | | | |
| 47 | 0.8 | 0.8 | | 1.2 | | | 1.2 | | |
| 48 | 0.8 | 0.8 | | | | | | 1.2 | 1.2 |
| 49 | | 0.8 | | | | | 0.4 | | |
| 50 | 0.8 | 0.8 | 1.2 | | | | | | |

| | LiCoO₂ | | Sb₂O₆ | Firing | | | | | | |
|---|---|---|---|---|---|---|---|---|---|---|
| Example | mol Li | mol Co | mol Sb | Temperature | L* | a* | b* | C* | h° | Color |
| 45 | | | | 1,150° C. | 36.4 | 8.2 | −9.2 | 12.3 | 311.8 | Very Pale |
| | | | | | | | | | | Dark Purple |
| 46 | | | | 1,150° C. | 39.0 | 15.3 | −21.1 | 28.1 | 305.8 | Violet |
| 47 | | | | 1,150° C. | 37.7 | 12.5 | 16.8 | 21.0 | 307.0 | Pale Violet |
| 48 | | | | 1,150° C. | 31.6 | 8.7 | −14.8 | 17.2 | 300.4 | Pale Violet |
| 49 | 0.8 | 0.8 | 1.2 | 1,150° C. | 33.9 | 8.6 | −13.1 | 15.7 | 303.4 | Pale Violet |
| 50 | | | 1.2 | 1,150° C. | 32.8 | 10.6 | −14.5 | 17.9 | 306.0 | Pale Violet |

### Example 51-60

Mixtures of cobalt oxide (Co₃O₄), titanium dioxide (TiO₂), lithium carbonate (Li₂CO₃), antimony trioxide (Sb₂O₃) and zinc oxide (ZnO) were weighed out in proportions according to the molar amounts listed in Table 6. The mixtures were homogenized by mortar and pestle and calcined in air at 1,150° C. for 4 hours. After firing, the color of the final product is listed in Table 6 and the colors ranged from pale violet to mauve.

TABLE 6
Composition, firing temperature and color data for Examples 51 to 60. CIE
color values for Examples 51-60 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | ZnO | Firing | | | | | | |
|---|---|---|---|---|---|---|---|---|---|---|---|---|
| Example | mol Co | mol Ti | mol Li | mol Sb | mol Zn | Temperature | L* | a* | b* | C* | h° | Color |
| 51 | 1 | 1 | 1 | 1 | | 1,150° C. | 34.3 | 9.2 | −16.6 | 18.9 | 299.1 | Pale Violet |
| 52 | 0.95 | 1 | 1 | 1 | 0.05 | 1,150° C. | 33.8 | 9.1 | −17.7 | 19.9 | 297.3 | Pale Violet |
| 53 | 0.9 | 1 | 1 | 1 | 0.1 | 1,150° C. | 35.0 | 9.3 | −18.6 | 20.8 | 296.4 | Pale Violet |
| 54 | 0.8 | 1 | 1 | 1 | 0.2 | 1,150° C. | 34.7 | 9.3 | −19.1 | 21.3 | 290.0 | Pale Violet |
| 55 | 0.6 | 1 | 1 | 1 | 0.4 | 1,150° C. | 40.2 | 8.8 | −19.1 | 21.1 | 294.8 | Pale Violet |
| 56 | 0.5 | 1 | 1 | 1 | 0.5 | 1,150° C. | 39.9 | 8.7 | −16.4 | 18.5 | 298.1 | Pale Violet |
| 57 | 0.4 | 1 | 1 | 1 | 0.6 | 1,150° C. | 43.7 | 9.2 | −13.8 | 16.6 | 303.5 | Light Pale |
| | | | | | | | | | | | | Violet |
| 58 | 0.2 | 1 | 1 | 1 | 0.8 | 1,150° C. | 52.0 | 10.2 | −9.0 | 13.6 | 318.6 | Mauve |
| 59 | 0.1 | 1 | 1 | 1 | 0.9 | 1,150° C. | 60.0 | 9.3 | −4.2 | 10.3 | 335.6 | Pale Mauve |
| 60 | 0.05 | 1 | 1 | 1 | 0.95 | 1,150° C. | 60.5 | 9.2 | −2.4 | 9.5 | 345.5 | Pale Mauve |

### Example 61-70

Mixtures of cobalt oxide (Co₃O₄), titanium dioxide (TiO₂), lithium carbonate (Li₂CO₃), antimony trioxide (Sb₂O₃) and magnesium carbonate (MgCO₃) were weighed out in proportions according to the molar amounts listed in Table 7. The mixtures were homogenized by mortar and pestle and calcined in air at 1,150° C. for 4 hours. After firing, the color of the final product is listed in Table 7 and the colors ranged from pale violet to light pastel violet.

TABLE 7
Composition, firing temperature and color data for Examples 61 to 70. CIE
color values for Examples 61-70 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | TiO₂ | Li₂CO₃ | Sb₂O₃ | MgCO₃ | Firing | | | | | | |
|---|---|---|---|---|---|---|---|---|---|---|---|---|
| Example | mol Co | mol Ti | mol Li | mol Sb | mol Mg | Temperature | L* | a* | b* | C* | h° | Color |
| 61 | 1 | 1 | 1 | 1 | | 1,150° C. | 33.4 | 9.5 | −18.0 | 20.4 | 297.9 | Pale Violet |
| 62 | 0.95 | 1 | 1 | 1 | 0.05 | 1,150° C. | 34.5 | 10.1 | −19.0 | 21.5 | 297.9 | Pale Violet |
| 63 | 0.9 | 1 | 1 | 1 | 0.1 | 1,150° C. | 35.0 | 10.1 | −19.1 | 21.6 | 297.7 | Pale Violet |
| 64 | 0.8 | 1 | 1 | 1 | 0.2 | 1,150° C. | 37.2 | 11.2 | −21.4 | 24.2 | 297.7 | Pale Violet |
| 65 | 0.6 | 1 | 1 | 1 | 0.4 | 1,150° C. | 42.2 | 12.0 | −22.9 | 25.9 | 297.7 | Pale Violet |
| 66 | 0.5 | 1 | 1 | 1 | 0.5 | 1,150° C. | 43.5 | 12.2 | −21.8 | 25.0 | 299.2 | Pale Violet |
| 67 | 0.4 | 1 | 1 | 1 | 0.6 | 1,150° C. | 46.3 | 12.2 | −20.0 | 23.4 | 301.4 | Light Pale Violet |
| 68 | 0.2 | 1 | 1 | 1 | 0.8 | 1,150° C. | 55.8 | 10.7 | −15.3 | 18.7 | 305.1 | Pastel Violet |
| 69 | 0.1 | 1 | 1 | 1 | 0.9 | 1,150° C. | 63.0 | 8.8 | −11.8 | 14.7 | 306.9 | Pastel Violet |
| 70 | 0.05 | 1 | 1 | 1 | 0.95 | 1,150° C. | 72.0 | 6.3 | −5.6 | 8.4 | 318.4 | Light Pastel Violet |

### Example 71-76

Mixtures of cobalt oxide (Co₃O₄), stannic oxide (SnO₂), lithium carbonate (Li₂CO₃) and antimony trioxide (Sb₂O₃) were weighed out in proportions according to the molar amounts listed in Table 8. The mixtures were homogenized by mortar and pestle and calcined in air at 1,180° C. for 4 hours. After firing, the color of the final product is listed in Table 8 and the colors ranged from dark mauve to orchid.

TABLE 8
Composition, firing temperature and color data for Examples 71 to 76. CIE
color values for Examples 71-76 measured as calcined powders in a cuvette with spectral
reflectance excluded on a PerkinElmer Lambda 950 UV/Vis/NIR with D65 illuminant
and 10° Standard Observer along with a general color descriptor.

| | Co₃O₄ | SnO₂ | Li₂CO₃ | Sb₂O₃ | Firing | | | | | | |
|---|---|---|---|---|---|---|---|---|---|---|---|
| Example | Co | Sn | Li | Sb | Temperature | L* | a* | b* | C* | h° | Color |
| 71 | 1 | 1 | 1 | 1 | 1,180° C. | 41.8 | 19.9 | −10.0 | 22.3 | 333.3 | Dark Mauve |
| 72 | 0.8 | 0.8 | 1.2 | 1.2 | 1,180° C. | 48.5 | 27.4 | −22.2 | 35.3 | 321.0 | Pale Purple |
| 73 | 0.6 | 0.6 | 1.4 | 1.4 | 1,180° C. | 54.7 | 29.2 | −24.8 | 38.3 | 319.7 | Pale Orchid |
| 74 | 0.4 | 0.4 | 1.6 | 1.6 | 1,180° C. | 59.6 | 34.0 | −32.2 | 46.8 | 316.5 | Orchid |
| 75 | 0.2 | 0.2 | 1.8 | 1.8 | 1,180° C. | 63.5 | 31.6 | −28.3 | 42.4 | 318.2 | Light Orchid |
| 76 | 0.1 | 0.1 | 1.9 | 1.9 | 1,180° C. | 70.9 | 27.8 | −24.6 | 37.1 | 318.6 | Pastel Orchid |

X-ray Powder Diffraction Data:

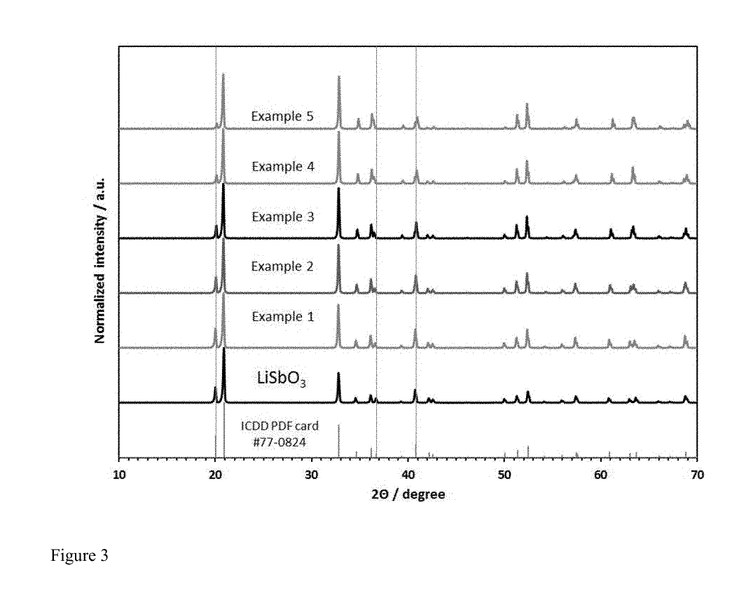

X-ray powder diffraction measurements were made at room temperature using a Rigaku X-ray diffractometer with Cu-Kα radiation at 40 kV and 40 mA. Powder diffraction measurements were made on Examples 1 to 8 along with single phase LiSbO₃, LiNbO₃, and LiTaO₃. The single phase samples were synthesized for comparison at temperatures of 2,100° F. (LiSbO₃), 1,800° F. (LiNbO₃), and 1,800° F. (LiTaO₃). The powder diffraction patterns for Examples 1 to 5 are displayed in FIG. 3 and consist of the solid solution Li₂₋ₓCoₓTiₓSb₂₋ₓO₆ for x=0.2, 0.4, 0.6, 0.8, and 1. The shifting of the powder diffraction peaks is indicative of the change in lattice parameters as the composition shifts from LiSbO₃ to LiCoTiSbO₆ (Example 5). The lattice parameters derived from these X-ray diffraction patterns are listed in Table 9. Overall the X-ray diffraction data displayed in FIG. 3 indicate that LiSbO₃ crystal structure holds for the full Li₂₋ₓCoₓTiₓSb₂₋ₓO₆ solid solution.

TABLE 9
Unit cell parameters derived from the powder diffraction pattern for Examples
1 to 8 along with parameters for LiSbO₃, LiNbO₃ and LiTaO₃ synthesized in the same
manner. CIE color values for Examples 1-8 measured as calcined powders in a cuvette
with spectral reflectance excluded on a PerkinElmer Lambda 950 UV/Vis/NIR with D65
illuminant and 10° Standard Observer along with a general color descriptor.

| | | x | a (Å) | ± | b (Å) | ± | c (Å) | ± | V (Å³) | Space Group |
|---|---|---|---|---|---|---|---|---|---|---|
| | LiSbO₃ | 0 | 5.195 | 0.0006 | 4.904 | 0.0005 | 8.504 | 0.0010 | 216.6 | Pncn |
| Example 1 | Li₂₋ₓCoₓTiₓSb₂₋ₓO₅ | 0.2 | 5.167 | 0.0008 | 4.895 | 0.0007 | 8.473 | 0.0011 | 214.3 | Pncn |
| Example 2 | | 0.4 | 5.158 | 0.0013 | 4.904 | 0.0013 | 8.473 | 0.0017 | 214.4 | Pncn |
| Example 3 | | 0.6 | 5.147 | 0.0007 | 4.907 | 0.0005 | 8.462 | 0.0010 | 213.7 | Pncn |
| Example 4 | | 0.8 | 5.159 | 0.0006 | 4.931 | 0.0005 | 8.490 | 0.0009 | 216.0 | Pncn |
| Example 5 | | 1 | 5.150 | 0.0003 | 4.934 | 0.0002 | 8.482 | 0.0004 | 215.5 | Pncn |

| | | | | | | | | | |
|---|---|---|---|---|---|---|---|---|---|
| Example 6 | Li_{5.2}Co_{0.8}Sn_{0.8}Sb_{3.2}O₆ | 5.255 | 0.0009 | 4.958 | 0.0007 | 8.589 | 0.0015 | 223.8 | Pnn2 |
| | LiNbO₃ | 5.155 | 0.0009 | 5.155 | 0.0009 | 13.870 | 0.0017 | 319.2 | R3c |
| Example 7 | Li_{1.9}Co_{0.1}Ti_{0.1}Nb_{1.9}O₆ | 5.153 | 0.0007 | 5.153 | 0.0007 | 13.870 | 0.0014 | 318.9 | R3c |
| | LiTaO₃ | 5.161 | 0.0012 | 5.161 | 0.0012 | 13.756 | 0.0022 | 317.3 | R3c |
| Example 8 | Li_{1.8}Co_{0.2}Ti_{0.2}Ta_{1.8}O₆ | 5.153 | 0.0004 | 5.153 | 0.0004 | 13.793 | 0.0008 | 317.2 | R3c |

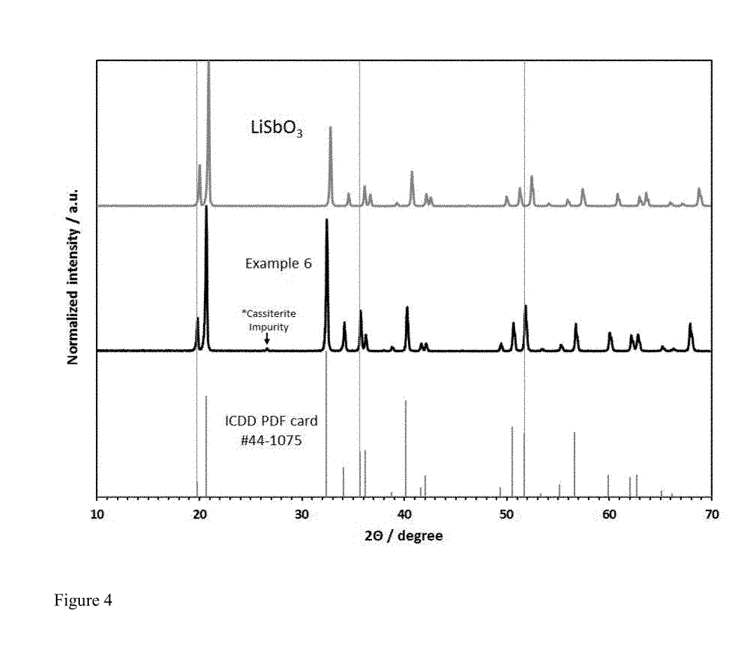

The X-ray diffraction pattern for Example 6 (Li_{1.2}Co_{0.8}Sn_{0.8}Sb_{1.2}O₆) is displayed in FIG. 4 along with single phase LiSbO₃. Aside from a small cassiterite impurity peak the powder diffraction pattern is consistent with the LiSbO₃ structure. The powder diffraction pattern for Li_{1.2}Co_{0.8}Sn_{0.8}Sb_{1.2}O₆ looks much like the diffraction pattern observed for the LiSbO₃—LiCoTiSbO₆ solid solution, but with a slight symmetry modification from Pnna to Pnn2 as indicated in Table 9.

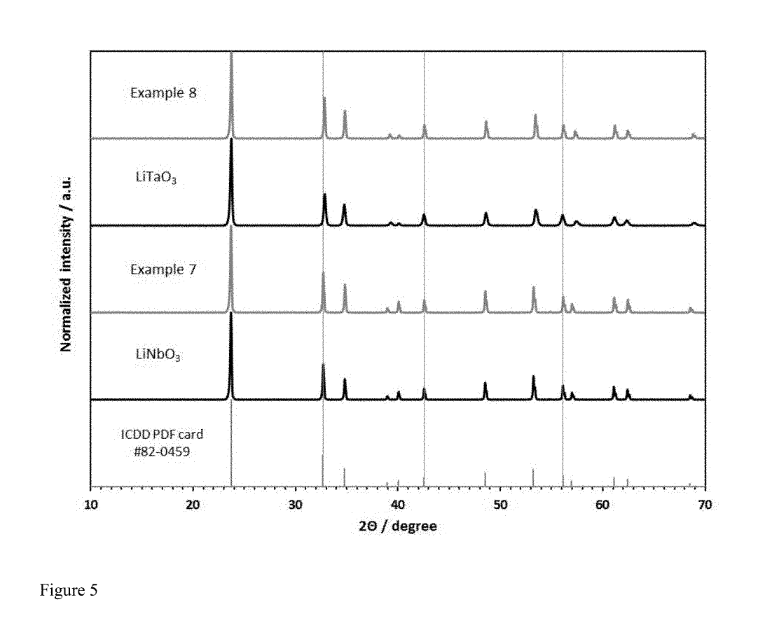

Single phase LiTaO₃ and LiNbO₃ are compared to Examples 7 (Li_{1.9}Co_{0.1}Ti_{0.1}Nb_{1.9}O₆) and 8 (Li_{1.8}Co_{0.2}Ti_{0.2}Ta_{1.8}O₆) in FIG. 5. The gray guide lines indicate the relative peak positions do not shift significantly between the examples and their parent compounds. The powder diffraction pattern for compositions displayed in FIG. 5 all fit the LiNbO₃-type crystal structure. The resulting lattice parameters for Examples 7 and 8 are displayed in Table 9 along with parameters derived from the LiNbO₃ and LiTaO₃ reference materials.

Particle Size Distribution Data:

In order to run color measurements the compositions from Examples 1 to 8 were ground to the particle size distributions listed in Table 10 below. Particle size distribution measurements were made using a Microtrac S3500 system and ranged from a fifty percentile of 2.8 microns to 4.8 microns. It should be noted that as the compositions are ground to a pigmentary particle size close to 1 micron the color shifts lighter and less chromatic.

TABLE 10
Particle size distribution data for Examples 1 to 8. CIE color values for
Examples 1-8 measured as calcined powders in a cuvette with spectral reflectance
excluded on a PerkinElmer Lambda 950 UV/Vis/NIR with D65 illuminant and 10°
Standard Observer along with a general color descriptor.
Particle Size Distributions

| | | Example 1 | Example 2 | Example 3 | Example 4 | Example 5 |
|---|---|---|---|---|---|---|
| | | Composition: | | | | |
| | | Li₂₋ₓCoₓTiₓSb₂₋ₓO₆ | | | | |
| | | X = 0.2 | X = 0.4 | X = 0.6 | X = 0.8 | X = 1 |
| | | Size (μm) | Size (μm) | Size (μm) | Size (μm) | Size (μm) |
| Percentiles | 10% | 1.69 | 1.177 | 1.687 | 1.025 | 1.355 |
| | 20% | 2.39 | 2.021 | 2.416 | 1.967 | 2.166 |
| | 30% | 2.94 | 2.647 | 2.951 | 2.618 | 2.737 |
| | 40% | 3.45 | 3.2 | 3.43 | 3.17 | 3.22 |
| | 50% | 3.95 | 3.75 | 3.9 | 3.69 | 3.69 |
| | 60% | 4.49 | 4.34 | 4.41 | 4.26 | 4.18 |
| | 70% | 5.11 | 5.01 | 4.99 | 4.92 | 4.73 |
| | 80% | 5.92 | 5.92 | 5.76 | 5.78 | 5.45 |
| | 90% | 7.24 | 7.45 | 7.04 | 7.27 | 6.59 |
| | 99% | 11.74 | 13.62 | 11.61 | 13.4 | 10.27 |

| | | | | | |
|---|---|---|---|---|---|
| Mean Volume | 4.28 | 4.18 | 4.22 | 4.08 | 3.91 |

| | | Example 6 | Example 7 | Example 8 |
|---|---|---|---|---|
| | | Composition: | | |
| | | Li_{1.2}Co_{0.8}Sn_{0.8}Sb_{1.2}O₆ | Li_{1.9}Co_{0.3}Ti_{0.1}Nb_{1.9}O₆ | Li_{1.8}Co_{0.2}Ti_{0.2}Ta_{1.8}O₆ |
| | | Size (μm) | Size (μm) | Size (μm) |
| Percentiles | 10% | 0.942 | 2.002 | 1.759 |
| | 20% | 1.565 | 2.79 | 2.314 |
| | 30% | 2.008 | 3.48 | 2.754 |
| | 40% | 2.396 | 4.13 | 3.18 |
| | 50% | 2.791 | 4.79 | 3.64 |
| | 60% | 3.23 | 5.49 | 4.16 |
| | 70% | 3.78 | 6.29 | 4.8 |
| | 80% | 4.53 | 7.33 | 5.71 |
| | 90% | 5.84 | 8.96 | 7.37 |
| | 99% | 10.2 | 13.95 | 14.88 |

| | | | |
|---|---|---|---|
| Mean Volume | 3.19 | 5.21 | 4.25 |

Reflectance Spectra/Color:

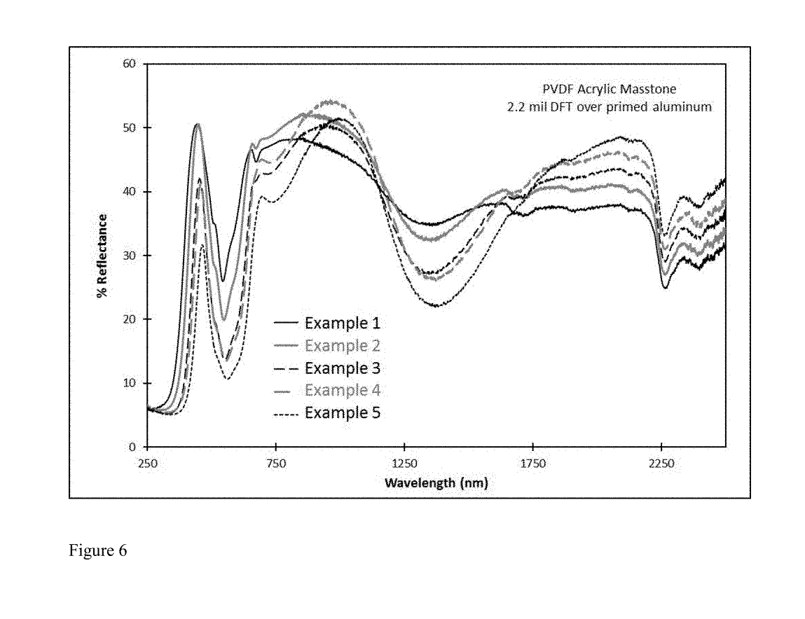

PVDF/Acrylic masstone coatings were prepared using pigments from Examples 1 to 8. The coatings were applied to primed alumina substrates with a final dry film thickness of 2.2 mil. The reflectance as a function of wavelength and CIE L*a*b* color values were measured on the PVDF/Acrylic masstone drawdowns using a Perkin Elmer Lambda 900 spectrophotometer. All CIE* color values are for a D65 illuminant and 10 degree observer. The reflectance spectra for Examples 1 to 5 are displayed in FIG. 6 and consist of the solid solution series Li₂₋ₓCoₓTiₓSb₂₋ₓO₆ for x=to 0.2, 0.4, 0.6, 0.8, and 1 as listed in Table 9. The CIE L*a*b* color values for the composition range (LiSb)₂₋ₓ(CoTi)₁₋ₓO₆ where (0.2≤x≤0.8) displays values of L* from 45 to 65, a* from 5 to 20, and b* from −15 to −25. The main features observed in FIG. 6 for the reflectance spectra include a group of at least three absorption bands between 490 nm and 630 nm that shift to longer wavelengths as x increases. The characteristic cobalt absorption band between 1150 nm and 1700 nm is also observed through the entire series.

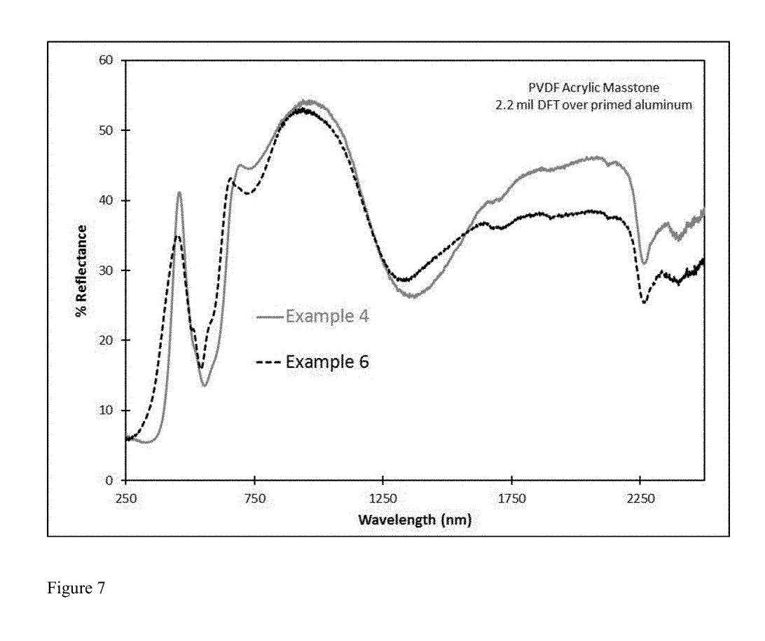

FIG. 7 below compares the PVDF acrylic masstone reflectance spectra for Examples 4 (Li_{1.2}Co_{0.8}Ti_{0.8}Sb_{1.2}O₆) and 6 (Li_{1.2}Co_{0.8}Sn_{0.8}Sb_{1.2}O₆). The substitution of titanium by tin in Example 6 sharpens and shifts the absorption bands at 554 nm to 538 nm and from 1360 nm to 1330 nm. The reflectance peak at 459 nm in Example 4 broadens and shifts to 451 nm with tin substitution in Example 6. The changes in the reflectance spectra translate into a color shift from L*=50.81, a*=12.54, and b*=−22.93 for Example 4 to L*=55.02, a*=18.11, and b*=−14.56 in Example 6. In general the CIE L*a*b* color values for the full composition range (LiSb)₂₋ₓ(CoSn)₁₋ₓO₆ where (0.2≤x≤0.8) displays values of L* from 50 to 70, a* from 15 to 30, and b* from −15 to −30.

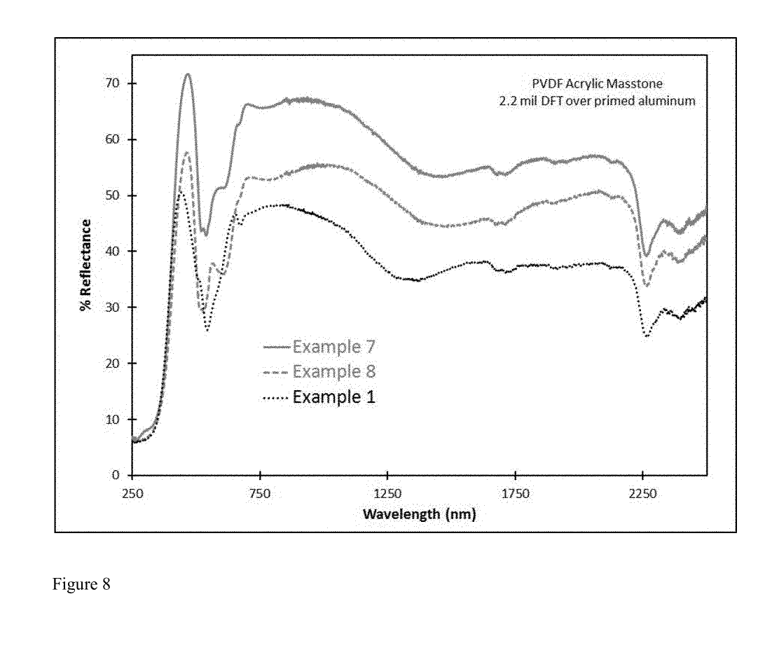

In contrast to the LiCoTiSbO₆—LiSbO₃ solid solution the LiNbO₃ and LiTaO₃ analogs with the LiNbO₃-type crystal structure display a narrow solid solution range where desirable color can be achieved. The most chromatic color for the Li₂₋ₓCoₓTiₓSb₂₋ₓO₆ and Li₂₋ₓSb₂₋ₓCoₓSnₓO₆ solid solutions occur where x ranges from 0.4≤x≤0.8, while in the case of Li₂₋ₓCoₓTiₓNb₂₋ₓO₆ and Li₂₋ₓCoₓTiₓTa₂₋ₓO₆ the values are close to x=0.1 and 0.2, respectively. In general the CIE L*a*b* color values for the full composition range (LiNb)₂₋ₓ(CoTi)₁₋ₓO₆ where (0.05≤x≤0.4) displays values of L* from 70 to 80, a* from 4 to 8, and b* from −5 to −15. In general the CIE L*a*b* color values for the full composition range (LiTa)₂₋ₓ(CoTi)₁₋ₓO₆ where (0.05≤x≤0.4) displays values of L* from 65 to 75, a* from 5 to 10, and b* from −10 to −20. FIG. 8 below shows the similarity between Examples 1 and Examples 7 and 8. The reflectance peaks (˜465 nm) for Examples 7 and 8 with the LiNbO₃-type crystal structure are shifted to slightly higher wavelengths relative to Example 1 (the LiSbO₃ analog). There is also a significant shift in the absorption bands between 500 nm and 700 nm with the formation of a step like feature (˜570 nm) in Examples 7 and 8. The changes in the reflectance spectra for Examples 7 and 8 result in colors that are shifted green with much lower a* values than Example 1 as shown in Table 11.

TABLE 11
CIE color values for Examples 1-8 measured as calcined powders in a
cuvette with spectral reflectance excluded on a PerkinElmer Lambda 950
UV/Vis/NIR with D65 illuminant and 10° Standard Observer along with
a general color descriptor.

| | CIE L* | CIE a* | CIE b* | C* | h° |
|---|---|---|---|---|---|
| Example 1 | 64.88 | 12.88 | −16.45 | 20.89 | 308.06 |
| Example 2 | 59.72 | 16.45 | −22.69 | 28.03 | 305.94 |
| Example 3 | 51.57 | 16.44 | −24.49 | 29.50 | 303.87 |
| Example 4 | 50.81 | 12.54 | −22.93 | 26.13 | 298.67 |
| Example 5 | 45.16 | 7.16 | −18.25 | 19.60 | 291.42 |
| Example 6 | 55.02 | 18.11 | −14.56 | 23.24 | 321.20 |
| Example 7 | 76.62 | 6.84 | −14.22 | 15.78 | 295.69 |
| Example 8 | 67.13 | 9.65 | −17.54 | 20.02 | 298.82 |

Perkin Elmer Lambda900 UV/VIS/NIR Spectrophotometer D65 illuminant with a 10 degree observer

Acid/Base Stability:

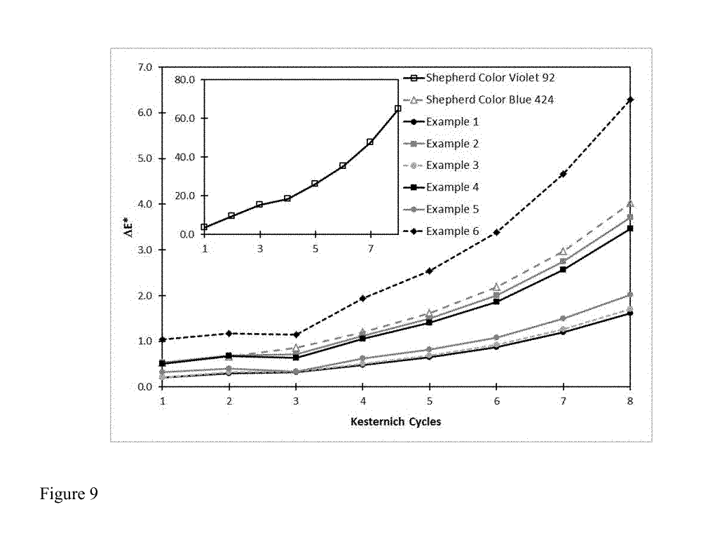

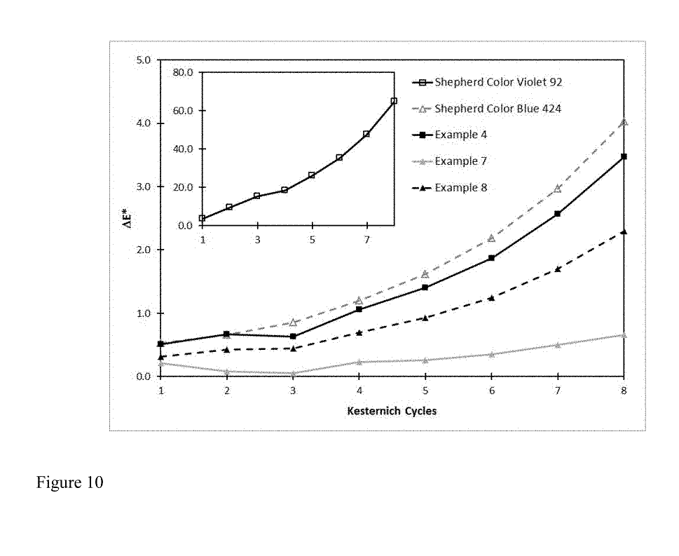

Modified Kesternich testing was performed in which primed aluminum panels coated with PVDF/acrylic underwent a series of 7-hour exposures to a sulfur dioxide atmosphere followed by measurements of color and gloss. The color measurements were performed on a Datacolor 600 reflection spectrophotometer and 60° gloss measurements were performed using a BYK Gardner Micro Tri-gloss meter. Along with drawdowns of Examples 1 through 8, C.I. Pigment Violet 14 (Shepherd Color Violet 92) and C.I. Pigment Blue 28 (Shepherd Color Blue 424) were included for comparison. The full Kesternich testing included a total of 8 cycles of 7-hour exposure to sulfur dioxide (SCTM 276). The color and gloss changes that occurred over these 8 cycles are displayed in FIGS. 9 through 12 below. The change in color is summarized in the ΔE* vs Kesternich cycle FIGS. 9 and 10 where ΔE*=√(ΔL*)²+(Δa*)²+(Δb*)²).

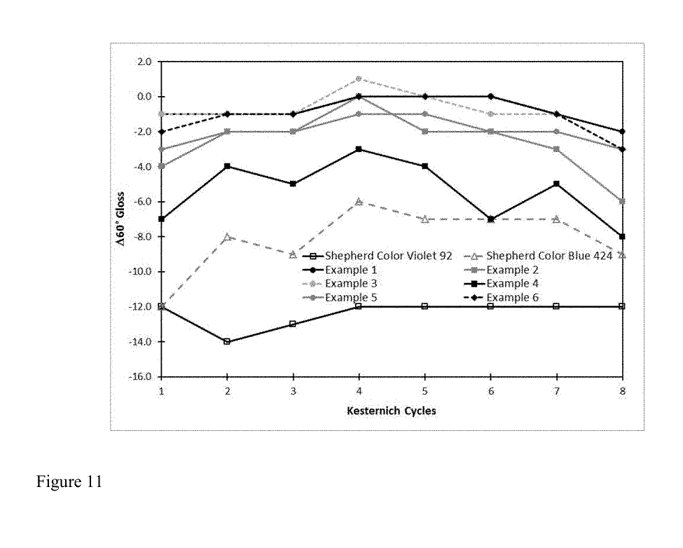

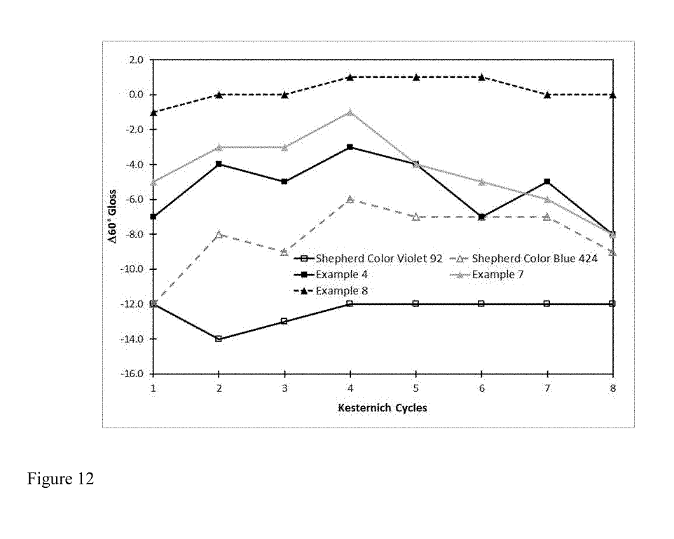

The insets to FIGS. 9 and 10 are included to show the change in color for Shepherd Color Violet 92 over the full set of 8 Kesternich cycles. In terms of ΔE* the Figures show that all the examples are much better than Shepherd Color Violet 92 and except for Example 6 (Li_{1.2}Co_{0.8}Sn_{0.8}Sb_{1.2}O₆) all the examples display similar or better behavior than Shepherd Color Blue 424. Example 7 (Li_{1.9}Co_{0.1}Ti_{0.1}Nb_{1.9}O₆) exhibited the lowest value with ΔE* much less than 1 following 8 exposure cycles. The gloss measurements in FIGS. 11 and 12 show that all the examples display a lower change in gloss than both Shepherd Color Violet 92 and Shepherd Color Blue 424. The smallest gloss difference is achieved in Examples 1 (Li_{1.8}Co_{0.2}Ti_{0.2}Sb_{1.8}O₆) and 8 (Li_{1.8}Co_{0.2}Ti_{0.2}Ta_{1.8}O₆).

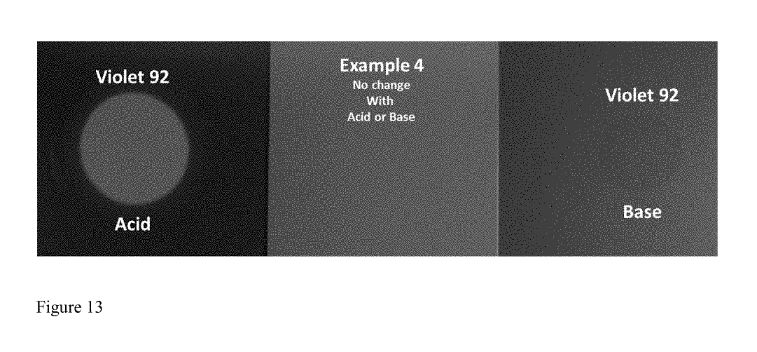

Along with standard Kesternich testing two additional acid/base stability tests were performed on Example 4. In the first of these tests PVDF/acrylic panels of Example 4 and Shepherd Color Violet 92 were exposed to 5% solutions of HCl and NaOH. During the test 1 milliliter aliquots of 5% HCl and 5% NaOH solutions are placed on two separate spots on each panel and then covered with watch glasses. After 24 hours of exposure the solutions are removed and the panels are cleaned and evaluated for signs of failure or color change. Once evaluated the acid/base solutions are placed back on the same spots on the panels and this process continues for seven days. The results of this testing are displayed in FIG. 13 below and show that following one day of exposure Example 4 is unchanged while Shepherd Color Violet 92 has changed color in both acid and base. The testing was continued on Example 4 for full seven day test duration with no observed change (see FIG. 13 below).

The second set of acid/base stability testing on Example 4 was performed on the pigment powder. During this test 1 gram of pigment based on Example 4 was placed in two separate 3 mL vials. The first of these vials was then filled with a 5% solution of HCl and the second filled with 5% NaOH. The samples were then monitored for color change to the powder or the solutions. In the case of Example 4 there was no observable change in color to the powder or solution following two months of exposure. As a reference Shepherd Color Violet 92 pigment powder was compared under the same conditions. Unlike Example 4, a color change was observed within hours for the vials containing Shepherd Color Violet 92.

Weathering:

Accelerated weathering measurements were performed with a QUV machine that included UV (WA-340 lamp) and moisture exposure. Test panels used for accelerated weathering are the same as the PVDF/acrylic drawdowns used for the modified Kesternich testing above. Color measurements were performed on a Datacolor 600 reflection spectrophotometer and 60° gloss measurements were performed using a BYK Gardner Micro Tri-gloss meter. Table 12 below shows the accelerated weather data at 500 and 1000 hours for Examples 1 to 8 and Shepherd Color Violet 92 and Blue 424. The weathering data in Table 12 show that overall change in color (ΔE*) is highest for Examples 1 and 2. As the composition increases in Co and Ti content in Examples 3 to 5, the ΔE* becomes lower than that for Blue 424 or Violet 92. The substitution of titanium by tin in Example 6 (Li_{1.2}Co_{0.8}Sn_{0.8}Sb_{1.2}O₆) also results in improved weathering over Violet 92 and Blue 424. Examples 7 and 8 with the LiNbO₃-type structure both display improved weathering over Violet 92 and Blue 424.

Pigments in the violet color space derived from the LiSbO₃ and LiNbO₃-type structures may have significant chemical and weathering stability over that of most violet pigments currently used in industry. In specific examples above the stability is such that these pigments are comparable in performance to the current industry standard complex inorganic pigments used for long term high durability applications.

TABLE 12
Accelerated weathering data for Examples 1-8, Shepherd Color Violet 92 and
Shepherd Color Blue 424 at 500 and 1000 hours for two different test panels. Test panels
were masstone drawdowns of PVDF/acrylic on primed aluminum. CIE color values for
Examples 1-8 measured as calcined powders in a cuvette with spectral reflectance
excluded on a PerkinElmer Lambda 950 UV/Vis/NIR with D65 illuminant and 10°
Standard Observer along with a general color descriptor.

| | | | 500 HOURS | | | | | 1000 HOURS | | | | |
|---|---|---|---|---|---|---|---|---|---|---|---|---|
| | | | | | | | Δ60° | | | | | Δ60° |
| | Sample | Panel # | ΔL* | Δa* | Δb* | ΔE* | Gloss | ΔL* | Δa* | Δb* | ΔE* | Gloss |
| PVDF/Acrylic | Blue 424 | 1 | −0.3 | −0.7 | 1.5 | 1.7 | 0 | −0.4 | −1.0 | 23 | 2.6 | 0 |
| Masstone | | 2 | −0.4 | −0.6 | 1.6 | 1.8 | 0 | −0.5 | −0.9 | 2.4 | 2.6 | 0 |
| | Violet 92 | 1 | 0.7 | −1.9 | 0.4 | 2.1 | −2 | 1.1 | −3.1 | 0.1 | 3.3 | −2 |
| | | 2 | 0.8 | −1.4 | 0.2 | 1.6 | −1 | 1.1 | −2.5 | −0.1 | 2.7 | −1 |
| | Example 1 | 1 | −2.9 | 0.1 | 5.9 | 6.6 | 0 | −3.6 | −0.1 | 6.9 | 7.8 | 0 |
| | | 2 | −2.7 | 0.0 | 5.9 | 6.5 | 0 | −3.4 | −0.2 | 6.8 | 7.6 | 0 |
| | Example 2 | 1 | −1.5 | −0.1 | 4.0 | 4.3 | −1 | −2.0 | −0.2 | 5.2 | 5.6 | −1 |
| | | 2 | −1.3 | 0.0 | 3.5 | 3.7 | −2 | −1.8 | −0.2 | 4.7 | 5.0 | −2 |
| | Example 3 | 1 | 0.0 | 0.5 | 0.3 | 0.6 | 0 | −0.2 | 0.4 | 0.7 | 0.8 | −1 |
| | | 2 | 0.1 | 0.4 | 0.4 | 0.6 | −1 | −0.1 | 0.4 | 0.8 | 0.9 | −1 |
| | Example 4 | 1 | 0.0 | 0.7 | 0.1 | 0.7 | −1 | 0.0 | 0.7 | 0.3 | 0.7 | −1 |
| | | 2 | 0.1 | 0.7 | 0.2 | 0.7 | −2 | 0.0 | 0.6 | 0.4 | 0.7 | −1 |
| | Example 5 | 1 | 0.0 | 0.7 | −0.3 | 0.8 | 0 | 0.0 | 0.7 | −0.1 | 0.8 | 0 |
| | | 2 | 0.1 | 0.8 | −0.4 | 0.9 | −1 | 0.0 | 0.8 | −0.2 | 0.9 | −1 |
| | Example 6 | 1 | −0.6 | 0.0 | 1.3 | 1.5 | −3 | −0.7 | −0.1 | 1.5 | 1.7 | −2 |
| | | 2 | −0.6 | 0.0 | 1.2 | 1.4 | −2 | −0.8 | −0.1 | 1.5 | 1.7 | −3 |
| | Example 7 | 1 | 0.0 | 0.7 | −1.3 | 1.4 | −1 | −0.2 | 0.5 | −1.0 | 1.1 | −1 |
| | | 2 | −0.1 | 0.5 | −1.0 | 1.1 | −2 | −0.2 | 0.4 | −0.7 | 0.9 | −2 |
| | Example 8 | 1 | 0.0 | 0.3 | −0.4 | 0.5 | −1 | −0.1 | 0.3 | −0.3 | 0.5 | −1 |
| | | 2 | −0.1 | 0.5 | −0.6 | 0.8 | 0 | −0.1 | 0.5 | −0.5 | 0.7 | 0 |

What is claimed:

1. Use of a colored pigment with median particle size less than 10 microns and a chromaticity (C*) greater than 10, comprising a compound with the LiSbO₃-type or LiNbO₃-type structure, that is stable to accelerated weathering and acid and base stable with a molar ratio:
(M₁M₅)_{2-x-y}(M₂M₄)ₓ(M₃M₃)_{y}O₆
where:
0≤x≤1;
0≤y≤1;
x+y≤1
and
where compositions with x+y=0 must contain a dopant addition M
where M₁ is Li, or Li in combination with Cu, Na, K, or combinations thereof; where M₂ is selected from Co, Cu, Mg, Mn, Ni, Zn, or combinations thereof; where M₃ is selected from Al, Co, Cr, Fe, Ga, In, Mn, Sb, or combinations thereof; where M₄ is selected from Sn, Ti, or combinations thereof; where M₅ is selected from Nb, Sb, Ta or combinations thereof; and where dopant M is selected from Al, B, Bi, Co, Cr, Cu, Fe, Ga, In, Mg, Mn, Mo, Ni, P, Sb, Si, Sn, Ti, W, Zr, or combinations thereof.

2. The use of a pigment of claim 1 where M₁ is Li, or Li in combination with Cu.

3. The use of a pigment of claim 1 where M₅ must include Sb.

4. The use of a pigment of claim 1 where M₂ is Co, or Co in combination with one or more of: Cu, Fe, Mg, Mn, Ni, or Zn.

5. The use of a pigment of claim 1 where M₂ is Co, or Co in combination with Mg, Zn or combinations thereof.

6. The use of a pigment of claim 1 with a hue angle (h°) between 290° and 320°.

7. The use of a pigment of claim 1 where M₃ is Al.

8. The use of a pigment of claim 1 where M₁ is at least 80 atomic % Li; and where M₅ is at least 80 atomic % Sb, Nb, or combinations thereof.

9. The use of a pigment of claim 1 where x+y<1.

10. The use of a pigment of claim 1 where x+y≠0, with no dopant present.

11. The use of a pigment of claim 1 in sol-gel type coatings, coil coatings (PVDF, polyester), cement, roofing granules, paint, ink, glass, enamel, ceramic glaze, plastics, sol-gel coatings, or decorative cosmetic applications.
